(19) United States
(12) Patent Application Publication
(10) Pub. No.: US 2010/0060136 A1
(43) Pub. Date: Mar. 11, 2010

(54) CATHODE FOR ELECTRON EMISSION

(75) Inventors: GEORG GARTNER, Aachen (DE); CORNELIS REINDER RONDA, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/720,841

(22) PCT Filed: Dec. 5, 2005
(86) PCT No.: PCT/IB05/54061

§ 371 Date: Jun. 5, 2007

(30) Foreign Application Priority Data
Dec. 9, 2004 (EP) 04106421.3

(51) Int. Cl. H01J 1/14

(52) U.S. Cl. 313/310; 313/346 R

(57) ABSTRACT

A cathode for electron emission, comprising a heating device (1, 2) for generating temperatures above 300° C., an electrically conductive cathode support (3) which is connected to the heating device (1, 2), and a cathode coating which is applied to the cathode support (3) and consists of an electron-emitting material (4) comprising at least one alkali metal selected from the group consisting of sodium, potassium, rubidium and cesium, with an emission current density >10 A/m2 at an operating temperature between 300° C. and 600° C.

The invention relates to a cathode for electron emission and to a vacuum electron tube, in particular a cathode ray tube.

Cathodes for electron emission are used in vacuum electron tubes, for example in conventional television sets or in devices for electron beam lithography. A distinction is made between so-called impregnated (I) and oxide (O) cathodes. On account of their metallic nature, so-called I cathodes (=dispenser cathodes) are able to durably supply much higher current densities than O cathodes. The magnitude of the current to be drawn depends on the electron work function of the emitting material and on the operating temperature. The operating temperatures of customary Os/Ru I cathodes for generating current densities in the region of 10 A/cm² are 960° C. The generation of such temperatures requires a complex and thus cost-intensive cathode structure, the mechanical stability of which on account of measures to reduce heat conduction leads to an increased fault rate of the cathodes and of the cathode ray tubes in mass production. In addition, such temperatures give rise to a high evaporation rate of the emitting material onto parts of the electron beam guide during operation in the vacuum electron tube, and this leads to frequent insulation problems in the electron beam guide device, also referred to as the electron beam optics, at the drawing voltages for focusing and deflecting the beam, said voltages often amounting to several thousand volts.

Document DE19961672 A1 describes a scandate dispenser cathode which, compared to conventional I cathodes, can supply a much higher current density at operating temperatures of 960° C. on account of a complex multilayer structure consisting of rhenium and scandium oxide on a tungsten metal body. The work function of 1.42 eV in such scandate dispenser cathodes would nevertheless require an operating temperature of more than 700° C. in order to produce a current density of more than 10 A/cm², and an operating temperature of more than 850° C. would be necessary for any peak currents of more than 100 A/cm² that are to be supplied, cf. document P-27, Technical Digest, IVESC Conference Orlando, Fla. (USA), 10-13 Jul. 2000. At these operating temperatures, insulation problems in the electron beam optics on account of the evaporation of the electron-emitting material during operation can be reduced only moderately. The operating temperatures, which are only slightly lower than those of commercially available Os/Ru I cathodes, do not permit any substantial simplification of the heating device but do give rise to cost-intensive production of a rhenium/scandium oxide multilayer structure. The prior art does not provide any indication as to how the operating temperature of a cathode can be further reduced while maintaining the same high emission currents and the same service life.

It is therefore an object of the present invention to provide a cost-effective and reliable cathode for electron emission which is able, while avoiding the disadvantages of the prior art, to supply sufficiently high current densities over a long time in a constant and reproducible manner.

This object is achieved by a cathode for electron emission, comprising a heating device for generating temperatures above 300° C., an electrically conductive cathode support which is connected to the heating device, and a cathode coating which is arranged on the cathode support and consists of an electron-emitting material comprising at least one alkali metal selected from the group consisting of sodium, potassium, rubidium and cesium, with an emission current density ≧10 A/m2 at an operating temperature between 300° C. and 600° C. An operating temperature ≧300° C. ensures continuous cleaning of the surface of the electron-emitting material by means of thermal evaporation of surface impurities, for example oxygen, which have an adverse effect on electron emission. By virtue of the advantageous electron-emitting material, an electron current density ≧10 A/m² is available even at operating temperatures ≦600° C. and therefore permits a considerably simplified and thus more cost-effective cathode design; in particular, the cathode support can be connected in a mechanically robust and thus reliable manner to the heating device, which does not require any special materials and/or heat-reflecting coatings. On account of the operating temperatures ≦600° C., the electron beam optics are only slightly soiled with evaporated material.

In one advantageous embodiment, the electron-emitting material comprises an alkali metal supply source for maintaining the emission current density. During operation, such cathodes are much less sensitive to critical gases such as for example oxygen, moisture or carbon dioxide, since evaporated or soiled electron-emitting material is continuously replaced.

Cathodes with a cathode support comprising a container for accommodating the electron-emitting material are advantageous, wherein the electron-emitting material comprises a porous matrix consisting of a mixture of zirconium grains and metal grains, preferably tungsten, nickel, rhenium and/or platinum, with a porosity of between 20% and 40% and an alkali metal alloy incorporated in the pores for supplying an alkali metal and/or alkali metal oxide cover for the surface of the porous matrix. Such cathodes (dispenser cathodes) make it possible to uniformly provide high current densities ≧10 A/m² over operating times of more than 10,000 hours.

Even more advantageous is the use of an alkali metal alloy comprising at least one material from the group consisting of alkali metal chromates, alkali metal-silicon alloys, alkali metal-tin alloys, in particular Cs₂Cr₂O₇, CsSiₖ or CsSnₖ, where 1<k<4, as a material located in the pores for supplying an alkali metal and/or alkali metal oxide cover for the surface of the porous matrix.

Particularly advantageous for handling of the cathodes prior to first operation thereof is a protective layer, in particular consisting of at least one material from the group consisting of W, Re, Ir, Pt, Ni, Ti, ZrC, TaC, which is applied to the electron-emitting material, said protective layer protecting the electron-emitting material against environmental influences, particularly if the protective layer has a thickness of between 0.3 μm and 3.0 μm.

In another advantageous embodiment, the electron-emitting material comprises a compact layer which is covered by an alkali metal and/or alkali metal oxide monolayer, said compact layer consisting of at least one material from the groups of alkali metal nitrides, alkali metal aluminates, alkali metal stannates, alkali metal aurides, Zintl phases, having a melting temperature above 300° C., which is provided for supplying the alkali metal and/or alkali metal oxide monolayer.

It is particularly advantageous if the compact layer has a thickness of between 10 nm and 100 nm so that the conductivity of the layer is sufficient to permit an emission current density ≧10 A/m².

It is even more advantageous if the cathode support comprises a protective device which covers some of the electron-emitting material above the electron-emitting material, as seen in the electron beam direction. In this way, some of the material evaporated from the heated cathode precipitates onto the side of the protective device located above the electron-emitting material, and therefore can no longer soil the cathode surroundings.

The invention also relates to a vacuum electron tube comprising at least one cathode as claimed in any of the preceding claims.

The invention will be further described with reference to examples of embodiments shown in the drawings to which, however, the invention is not restricted.

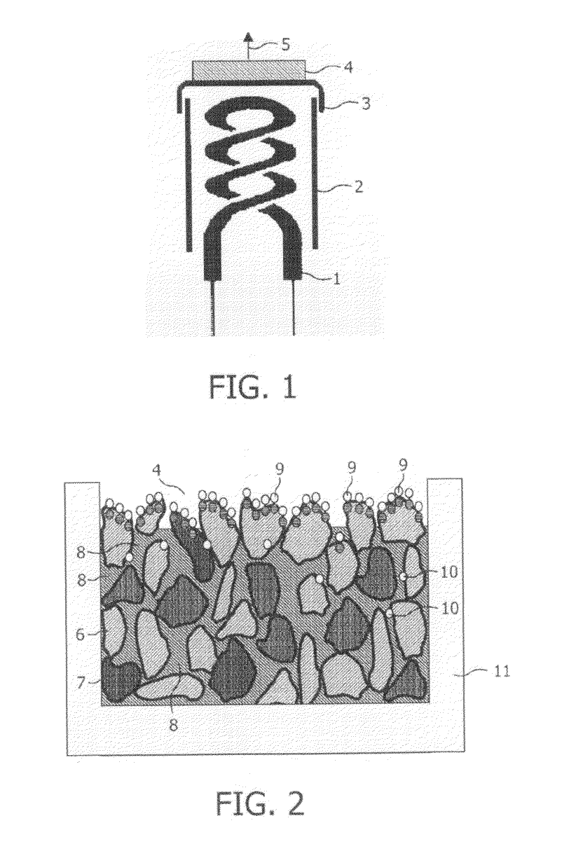

FIG. 1 shows a cathode with heating device.

FIG. 2 shows the schematic structure of a cathode support comprising a container for accommodating the electron-emitting material according to the invention.

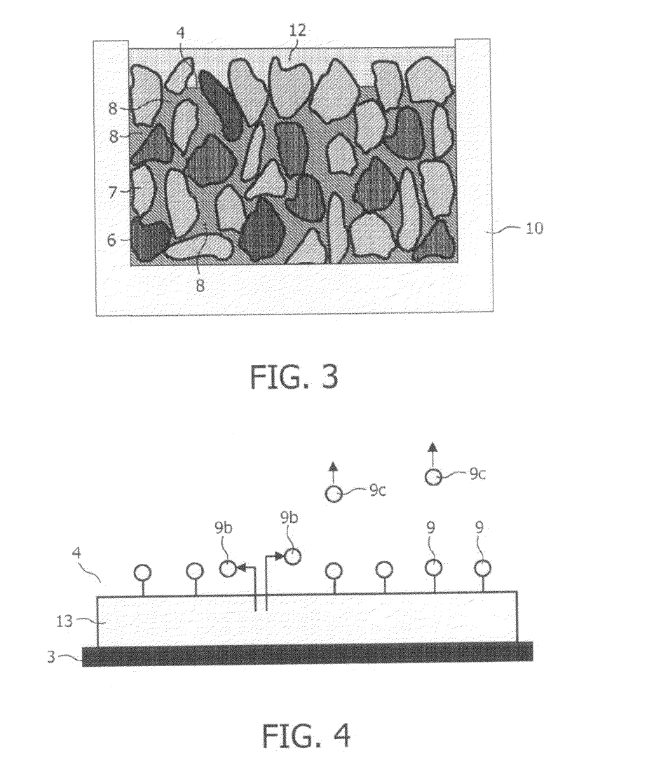

FIG. 3 shows the schematic structure of a cathode support comprising a container for accommodating the electron-emitting material according to the invention, with a protective layer.

FIG. 4 shows the schematic structure of a cathode support comprising a compact electron-emitting material according to the invention.

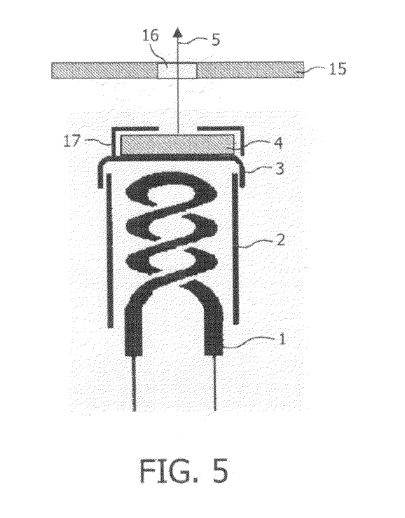

FIG. 5 shows a cathode according to the invention with a protective device.

FIG. 1 shows one embodiment of a cathode according to the invention for installation in a vacuum electron tube, which typically comprises the functional groups for electron beam generation and electron beam focusing and electron beam deflection, to which an operating voltage usually of several thousand volts is applied. The device for electron beam focusing and electron beam deflection is also referred to as the electron beam optics. Depending on the embodiment, the vacuum electron tube also comprises a fluorescent screen or a target object onto which the electron beam is directed. The electron beam generation system contains an arrangement consisting of at least one cathode. By way of example, the electron beam generation system may be one or more point cathodes or a system consisting of one or more wire cathodes, strip cathodes or flat cathodes. The cathodes need not emit over their entire surface. The cathode comprises a heating element which consists of a heating coil 1 and a cathode shaft 2, and an electrically conductive cathode support 3, onto which the electron-emitting material 4 is applied. The shape of the heating element shown in FIG. 1 represents merely an example of a heating element, and said heating element may also be embodied differently by the person skilled in the art. The electrons 13 emitted from the electron-emitting material 4 during operation are supplied via the electrically conductive cathode support 3. The heating of the electron-emitting material takes place via heating of the cathode support 3 by means of heat conduction or radiation heat from the heating coil 1 and by means of heat conduction via the cathode support 3. The temperature of the cathode support and thus the temperature of the electron-emitting material can be adjusted by means of the operating voltage of the heating coil.

The evaporation of the electron-emitting material, which is reduced compared to typical I cathodes on account of the relatively low operating temperature of the cathode according to the invention, can be even further reduced if the cathode support 3 comprises a protective device 17 (cf. FIG. 5) which covers the region of the electron-emitting material 4 which is non-emitting on account of the field distribution of the electron beam focusing and deflection devices but is nevertheless at the operating temperature. The material evaporated from the non-emitting region then precipitates onto the side of the protective device 17 which faces the electron-emitting material. In this way, it is possible to prevent soiling of the part 15 of the electron beam focusing and deflection devices and thus possible insulation problems. The region of the electron-emitting material 4 from which the electron beam 5 is drawn remains uncovered. The soiling of the portion of the part 15 of the electron beam focusing and deflection devices which lies above the emitting region is, however, less critical since a cutout 16 is located there for beam guidance purposes and material can rarely precipitate on the edge of the cutout for geometric reasons.

FIG. 2 shows the electron-emitting material 4 according to the invention in a container 11 which is arranged on the cathode support 3 or forms part of the cathode support 3. The container 11 is filled with a porous matrix consisting of a mixture of zirconium grains 6 and metal grains 7, in particular tungsten, nickel, rhenium and/or platinum. The matrix is typically produced by compression of the starting materials in powder form. It would also be possible to produce such a matrix by foaming and cooling a suitable alloy. The porosity of the matrix is preferably 20% to 40% in order to hold an amount of alkali metal alloy 8 which is sufficient for the operating time of the cathode. The alkali metal alloy is introduced into the matrix in the liquid state at temperatures above the melting point of the alkali metal alloy (pore material), preferably under a protective gas. Usually, a melt of pore material is produced and the porous matrices are added to the melt. After a sufficient time, the pores are completely filled with pore material and the matrices are removed again from the melt and cooled to room temperature. At an increased temperature, for example at the operating temperature, the alkali metal alloy 8 reacts with the matrix surface and elemental alkali metal 10 is formed, which then covers the surface of the electron-emitting material and considerably lowers the work function of the electron-emitting material. By way of example, a Cs—O₂ cover on a tungsten surface reduces the work function from 4.5 eV (for tungsten) to 1.2 eV. Another suitable material with a similar work function would be Rb-oxide on ruthenium. The cover comprising alkali metals and/or alkali metal oxides 9 is volatile at raised temperatures, for example at operating temperatures, so that, during operation of the cathode, elemental alkali metal 10 has to be continually formed from a chemical reaction of the alkali metal alloy 8 with the matrix 6 and 7. By way of example, a chemical reaction between a cesium bichromate alloy with zirconium grains of the matrix releases elemental cesium as follows:

Cs₂Cr₂O₇+2Zr→2Cs+2ZrO₂+Cr₂O₃

The cesium 10 which is released diffuses toward the surface of the electron-emitting material 4 and, together with oxygen which comes either from the matrix or from the residual gas of the device in which the cathode is installed, forms the work-function-reducing alkali metal and/or alkali metal oxide cover 9 on the surface of the porous matrix. Cesium can nevertheless also be produced by a chemical reaction of the matrix material with other alloys, for example CsSiₖ or CsSnₖ, where 1<k<4. The quantity of alkali metal alloy contained in the container and the non-oxidized zirconium surface, along with the operating temperature, determine the possible operating time of the Cs-containing cathode which is described here by way of example, wherein operating times of more than 10,000 h can be achieved.

In one advantageous embodiment, the electron-emitting material is coated with a protective layer 12 as shown schematically in FIG. 3. Alkali metal compounds are characterized by their propensity for reacting with oxygen, water and CO₂, and without a protective layer 12 this would place high requirements on the environmental conditions during production and storage of the cathodes and on the installation thereof in vacuum electron tubes and the process conditions therefor. Handling of the cathodes in a noble gas or dry nitrogen atmosphere would be possible but complicated. By contrast, a protective layer 12, in particular having a thickness of between 0.3 μm and 3.0 μm, protects the electron-emitting material 4 against environmental influences. The upper limit of the thickness of the protective layer 12 results from the further operating requirements. Since the protective layer 12 covers all of the electron-emitting material 4, in this state no alkali metal atoms 10 can reach the surface of the electron-emitting material 4. By virtue of a suitable heat treatment of the cathode in the installed state in the vacuum electron tube, for example at a so-called activation temperature above 300° C., the protective layer breaks up and the alkali metal and/or alkali metal oxide 9 can cover the surface of the electron-emitting material 4 and/or of the protective layer 12. It is therefore advantageous if the protective layer 12 consists of at least one material from the group consisting of W, Re, Ir, Pt, Ni, Ti, ZrC, TaC. By way of example, a work function of 0.85 eV is obtained for a Cs-covered TaC layer.

The cathode according to the invention gives very good emission current densities at low operating temperatures, for example emission current densities for Cs-containing cathodes of more than 14 A/cm² at an operating temperature of 480° C. This corresponds to a reduction in the operating temperature by 500° C. compared to conventional I cathodes for the same emission properties. At an operating temperature of 590° C., emission current densities of more than 130 A/cm2 are obtained, and this corresponds to a reduction in the operating temperature by about 300° C. even compared to scandate dispenser cathodes.

In another embodiment, use is not made of a porous matrix for holding and releasing alkali metals, but rather the electron-emitting material 4 which is used is a compact layer 13 consisting of alkali-metal-containing materials for forming an alkali metal and/or alkali metal oxide cover 9 for the compact layer 13, cf. FIG. 4. The layer 13 has a sufficiently high melting temperature and a sufficient chemical stability for forming a stable compact layer at the operating temperature. Suitable materials for a cathode according to the invention comprise at least one material from the groups of alkali metal nitrides (for example NaBa₃N, Na₅Ba₃N), alkali metal aluminates, alkali metal stannates (for example K₄₁Sn₁₂O₁₆, K₄SnO₃), alkali metal aurides (for example NaAu₂, K₂Au₃, RbAu, CsAu, NaAuGe, Rb₃AuO), Zintl phases (for example NaSi, CsSi, K₃P). These compounds have melting temperatures above 300° C. and are suitable for thermally releasing 9b the alkali metals and/or alkali metal oxides. In this case, too, any oxygen that is required may come from the residual gas of the vacuum electron tube. By way of example, the melting point of Cs—Au is 590° C. Cs—Au can therefore be used as the electron-emitting material in a temperature range between 300° C. and 550° C. The vapor pressure of cesium in Cs—Au permits a Cs release 9b at a rate which permits a sufficient cover 9 of the Cs—Au surface which is constant over a long time, and compensates for evaporation losses 9c. The layer 13 has a preferred thickness of between 10 nm and 100 nm, so that the material has a sufficient electrical conductivity to supply the electrons that are emitted from the cathode to the emitting surface. Where necessary, dopings which increase the conductivity may be added to the compact layer 13.

The embodiments explained with reference to the figures and the description are merely examples of a cathode for electron emission or of a vacuum electron tube, and are not intended to be understood as restricting the patent claims to these examples. Alternative embodiments are also possible for the person skilled in the art, and these are also covered by the scope of protection of the patent claims. The numbering of the dependent claims is not intended to imply that other combinations of the claims do not also constitute advantageous embodiments of the invention.

1. A cathode for electron emission, comprising a heating device (1, 2) for generating temperatures above 300° C., an electrically conductive cathode support (3) which is connected to the heating device (1, 2), and a cathode coating which is applied to the cathode support (3) and consists of an electron-emitting material (4) comprising at least one alkali metal selected from the group consisting of sodium, potassium, rubidium and cesium, with an emission current density ≧10 A/m² at an operating temperature between 300° C. and 600° C.

2. A cathode for electron emission as claimed in claim 1, characterized in that the electron-emitting material (4) comprises an alkali metal supply source for maintaining the emission current density.

3. A cathode for electron emission as claimed in claim 2, characterized in that the electron-emitting material (4) comprises a porous matrix consisting of a mixture of zirconium grains (6) and metal grains (7), preferably tungsten, nickel, rhenium and/or platinum, with a porosity of between 20% and 40% and an alkali metal alloy (8) incorporated in the pores of the matrix for supplying an alkali metal and/or alkali metal oxide cover (9) for the surface of the porous matrix, and the cathode support (3) comprises a container (11) for accommodating the electron-emitting material (4).

4. A cathode for electron emission as claimed in claim 3, characterized in that the alkali metal alloy (8) comprises at least one material from the group consisting of alkali metal chromates, alkali metal-silicon alloys, alkali metal-tin alloys, in particular Cs₂Cr₂O₇, CsSiₖ or CsSnₖ, where 1<k<4.

5. A cathode for electron emission as claimed in claim 3, characterized in that a protective layer (12), in particular consisting of at least one material from the group consisting of W, Re, Ir, Pt, Ni, Ti, ZrC, TaC, is applied to the electron-emitting material, said protective layer protecting the electron-emitting material (4) against environmental influences.

6. A cathode for electron emission as claimed in claim 5, characterized in that the protective layer (12) has a thickness of between 0.3 μm and 3.0 μm.

7. A cathode for electron emission as claimed in claim 2, characterized in that the electron-emitting material (4) comprises a compact layer (13) which is covered by an alkali metal and/or alkali metal oxide monolayer (9), said compact layer consisting of at least one material from the groups of alkali metal nitrides, alkali metal aluminates, alkali metal stannates, alkali metal aurides, Zintl phases, having a melting temperature above 300° C., for supplying the alkali metal and/or alkali metal oxide monolayer (9).

8. A cathode for electron emission as claimed in claim 7, characterized in that the compact layer (13) has a thickness of between 10 nm and 100 nm.

9. A cathode for electron emission as claimed in claim 1, characterized in that the cathode support (3) comprises a protective device (17) which covers some of the electron-emitting material (4) above the electron-emitting material (4), as seen in the electron beam direction (5).

10. A vacuum electron tube comprising at least one cathode as claimed in claim 1.
